(19) United States
(12) Patent Application Publication
(10) Pub. No.: US 2019/0139074 A1
(43) Pub. Date: May 9, 2019

(54) METHOD OF PROVIDING REBATE INFORMATION TO A REMOTE USER DEVICE OF A USER AND SYSTEM THEREOF

(71) Applicant: LIQUID GROUP PTE LTD, Singapore (SG)

(72) Inventor: Jeremy Tan, Singapore (SG)

(73) Assignee: LIQUID GROUP PTE LTD, Singapore (SG)

(21) Appl. No.: 16/015,511

(22) Filed: Jun. 22, 2018

Related U.S. Application Data
(63) Continuation of application No. PCT/SG2016/050625, filed on Dec. 29, 2016.
(60) Provisional application No. 62/272,920, filed on Dec. 30, 2015.
(60) Provisional application No. 62/273,733, filed on Dec. 31, 2015.

(51) Int. Cl. G06Q 30/02; G06F 16/955; G06Q 20/22

(52) U.S. Cl. CPC G06Q 30/0234; G06Q 20/227; G06F 16/955

(57) ABSTRACT

The present invention provides a method of providing rebate information over a communication network to a remote user device of a user. The method includes receiving, from the user device over the communication network, a transaction profile having at least a user account identifier associated to a user account; retrieving, from a database, a plurality of payment modes associated with the user account based on the user account identifier; determining rebate information for each of the plurality of payment modes; and transmitting, over the communication network, the rebate information for each of the plurality of payment modes to the user device. The present invention further provides a system for implementing the method.

### CROSS-REFERENCES TO RELATED APPLICATIONS

This application claims priority to and is a continuation of International Patent Application No. PCT/SG2016/050625, filed Dec. 29, 2016; which claims priority from U.S. Provisional Application No. 62/272,920, filed Dec. 30, 2015 and U.S. Provisional Application No. 62/273,733, filed Dec. 31, 2015. The entire contents of these applications are incorporated by reference herein in their entirety for all purposes.

### FIELD OF THE INVENTION

The present invention relates to a method of providing rebate information over a communication network to a remote user device of a user.

### BACKGROUND OF THE INVENTION

In a credit card transaction as shown in FIG. 1, when a cardholder or consumer makes a purchase, the cardholder presents a payment card to the merchant to initiate a payment transaction. The merchant or an acquirer associated to the merchant may then transmit a payment authorization request for the payment transaction to a payment scheme or network. An acquirer is an entity, e.g. a bank or financial institution, that may process a card payment transaction on behalf of the merchant. A payment scheme or network is a system or network for carrying out electronic payment transaction or using cash-substitutes to carry out a transaction. Examples of a payment scheme or network may be Mastercard™, VISA™, American Express™, PayPal™ The merchant or acquirer may through the payment scheme or network check the consumer's balance status with an issuer. An issuer is an entity, e.g. a bank or financial institution, that provides a letter or line of credit in favour of the consumer and is responsible for the consumer's ability to pay the credit accumulated by the consumer. The acquirer may communicate with the issuer via the payment scheme or network to check the balance status of the consumer. The issuer may provide the balance status of the consumer to the acquirer. Based on the balance status, the acquirer may inform the merchant and the merchant may accept or reject the payment transaction.

Conventionally, when a consumer selects an electronic payment method (e.g. credit card, debit card, etc.), the consumer is unaware of the cost of their choice of method of payment or payment mode to the merchant. For example, in a credit card payment transaction (as illustrated in FIG. 1), the merchant typically pays the acquirer a predetermined fee for the transaction which may be based on a number of factors including the type of payment card. The fee is based on the interchange fee between the issuer and the acquirer and the fee is passed on to the merchant in the form of a merchant ‘discount’ rate. Alternatively, the consumer may pay from his bank account or other proprietary forms of e-wallets or prepaid credits where the cost to the merchant may be lower since the interchange fees (or scheme based interchange fees) do not apply. As shown, electronic payment methods have inevitably passed the burden and cost of the processing the electronic payment to complete a transaction to the merchant, who may then pass the cost back to consumers in the form of price increases.

Currently, the consumer is usually unaware of the differences in transaction fees and therefore, the cost of the transaction to the merchant. Further, the purchase price or sale amount of a purchase is usually not affected by the choice of payment by the consumer. In some circumstances, merchants are explicitly barred from displaying the specific cost of transaction fees or transaction cost to the consumers. Regulatory bodies from certain jurisdictions have stepped in to permit merchants to pass on specific payment processing costs to consumers, this however has resulted in certain merchants inflating such costs to consumers. Specifically, current electronic payment methods are deficient in providing users with real-time data on transaction fees or cost.

There may be instances where the merchant may reduce the purchase price or sale amount if a consumer makes payment by cash or by debiting his bank account. However, this only occurs at the option or discretion of the merchant. The merchant may sometimes offer a reduction in purchase price or a rebate based on the use of different types of payment cards for promotional purposes with the issuer but this is usually not based on the cost of the transaction and does not apply across all payment options. Further, such reduction in prices or rebates are pre-determined and independent of the cost of the transaction.

During a transaction, the issuer may provide a rebate to the consumer. However, even when the issuer allows the consumer to obtain rebate, the rebate is usually made on the consumer's card from the merchant and the issuer is required to obtain the merchant's consent and require the merchant to install certain software on the merchant's devices or terminals. In this case, the rebate process is not straightforward and requires additional steps and resources to implement the rebate process.

Therefore, consumers are usually ignorant of any rebates and would often pay the transaction amount shown to them without knowing if a rebate is available for the method of payment used. Even if a rebate is to be made to the consumers, the process is not straightforward and requires additional resources. As such, there is a need for a technical solution to overcome the abovementioned issues.

### SUMMARY OF THE INVENTION

According to various embodiments, the present invention provides a method of providing rebate information over a communication network to a remote user device of a user. The method includes receiving, from the user device over the communication network, a transaction profile having at least a user account identifier associated to a user account; retrieving, from a database, a plurality of payment modes associated with the user account based on the user account identifier; determining rebate information for each of the plurality of payment modes; transmitting, over the communication network, the rebate information for each of the plurality of payment modes to the user device.

According to various embodiments, the method further includes receiving a payment response from the user device, such that the payment response may include a payment mode selected from the plurality of payment modes by the user.

According to various embodiments, the transaction profile may further include a merchant identifier associated to a merchant, such that the method may further include transmitting payment instruction to a payment network to initiate payment to the merchant.

According to various embodiments, the method may further include providing a rebate viewing application which may be downloadable by the user for installation on the user device.

According to various embodiments, the method may further include retrieving at least one of merchant rebate information from a merchant database of the merchant and acquirer rebate information from an acquirer database of an acquirer.

According to various embodiments, the method may further include transmitting the plurality of payment modes to the user device.

According to various embodiments, the transaction profile may include a sale amount for a good or service that the user intends to purchase, such that the method may further include computing a transaction amount for each of the plurality of payment modes, such that the transaction amount may be based on the rebate information, the transaction cost for each of the plurality of payment modes and the sale amount.

According to various embodiments, the step of transmitting the rebate information for each of the plurality of payment modes to the user device may include transmitting the transaction amount for each of the plurality of payment modes to the user device, such that the transaction amount incorporates the rebate information.

According to various embodiments, the rebate information may be generated based on at least one of a merchant transaction cost and a user transaction cost.

According to various embodiments, the rebate information may be generated based on the sale amount.

According to various embodiments, the present invention may further provide a system for providing rebate information over a communication network to a remote user device of a user. The system includes a user account database configured to store at least one user account entry associated to a user account, each user account entry may include at least a plurality of payment modes, a receiving unit configured to receive, from the user device over the communication network, a transaction profile having at least a user account identifier associated to the user account; a processing unit configured to retrieve, from the user account database, a plurality of payment modes associated with the user account based on the user account identifier and determine rebate information for each of the plurality of payment modes; a transmitting unit configured to transmit, over the communication network, the rebate information for each of the plurality of payment modes to the user device.

According to various embodiments, the receiving unit may be configured to receive a payment response from the user device, such that the payment response may include a payment mode selected from the plurality of payment modes by the user.

According to various embodiments, the transaction profile further may include a merchant identifier associated to a merchant, such that the transmitting unit may be configured to transmit payment instruction to a payment network to initiate payment to the merchant.

According to various embodiments, the system may further include a system database configured to store a rebate viewing application which may be downloadable by the user for installation on the user device.

According to various embodiments, the processing unit may be configured to retrieve at least one of merchant rebate information from a merchant database of the merchant and acquirer rebate information from an acquirer database of an acquirer.

According to various embodiments, the transmitting unit may be configured to transmit the plurality of payment modes to the user device.

According to various embodiments, the transaction profile may include a sale amount for a good or service that the user intends to purchase, such that the processing unit may be configured to compute a transaction amount for each of the plurality of payment modes, such that the transaction amount may be based on the rebate information, the transaction cost for each of the plurality of payment modes and the sale amount.

According to various embodiments, the transmitting unit may be configured to transmit the transaction amount for each of the plurality of payment modes to the user device, such that the transaction amount incorporates the rebate information.

According to various embodiments, the rebate information may be generated based on at least one of a merchant transaction cost and a user transaction cost.

According to various embodiments, the rebate information may be generated based on the sale amount.

The system addresses the deficiencies in the current payment mechanisms, which do not provide transparency to consumers in terms of the payment processing fees for their choice of payment methods. The system optimizes the payment options available to the consumer in real time, which enables the consumer to choose to receive savings or a rebate from the merchant.

The system provides a method of aggregating and processing in real time the variable components involved in each consumer's choice of payment options and their relative transaction cost. By presenting the information in real time to consumers, the system enables the consumers to make more informed choices between direct rebates and savings and the variety of rewards by payment methods based on their choice of payment. Further, the system provides the significantly advantageous feature of calculating a rebate for each transaction instead of using predetermined or fixed rebates. The system is also based on each individual consumer's available payment options, the location of purchase of merchant and consumer, the type of merchant, and based on the merchant's choice of determining the rebate.

Further, the system provides a rebate process that is straightforward and does not require additional resources to implement onto existing systems.

Thus, the present invention provides a system that takes into account the increasing granularity of interchange fees, which the various card schemes apply to different card types, an aggregation of a wide variety of non-card scheme type of payment methods, and provides real time computing of cost savings, and relevant rebates to consumers based on the consumer's choice of payment method. The system takes into account all of a consumer's available payment options where the system aggregates the cost involved in all payment options available to a customer for each transaction in real time. The system may be able to calculate rebates/fees to a consumer that is based on a plurality of variables including the interchange fees of the large variety of cards, respective merchant discount rates, applicable card scheme-related fees, applicable payment fees of bank systems, where the transaction is made and who the transaction involves. Further, the ecosystem for payment cards has become and continues to be more complex. However, the system according to the embodiments disclosed herein is able accommodate many more combinations and permutations, or any other future electronic payment methods. For example, the system according to the embodiments disclosed herein can accommodate all the new upcoming wallets and digital credits as well.

### BRIEF DESCRIPTION OF THE DRAWINGS

FIG. 1 shows an example of a flow diagram of a payment transaction.

FIG. 2 shows an example of a system for providing rebate information over a communication network to a remote user device.

FIG. 3 shows an example of a method of the system in FIG. 2.

FIG. 4 shows an example of a schematic flow diagram of the method in FIG. 3.

FIG. 5a-5j show examples of the screen captures of the display of the user device.

FIG. 6 shows an example of the server of the system in FIG. 2.

### DETAILED DESCRIPTION OF THE INVENTION

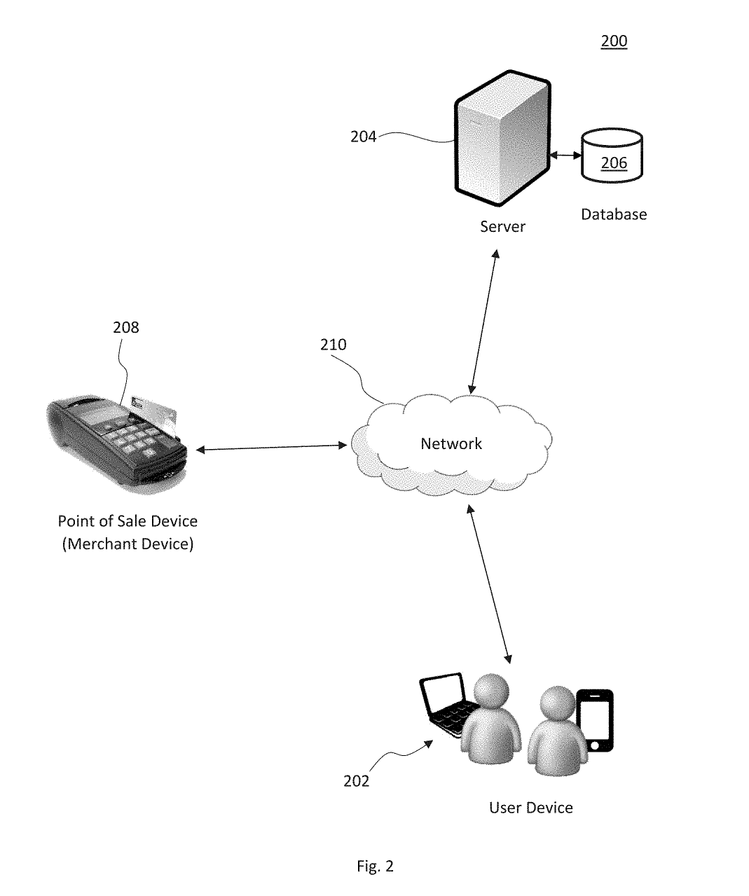

FIG. 2 shows an example of a system 200 for providing rebate information over a communication network 210 to a remote user device 202. System 200 may be suitable for providing a user a plurality of payment modes for the user to select a preferred payment mode. Specifically, the system 200 may provide the user a transaction amount for each of the plurality of payment modes so that the user is able to select one of the plurality of payment modes to carry out a payment transaction. In the following, the term “user” may be a consumer who makes a purchase at a merchant.

As shown in FIG. 2, the system 200 may include user device 202 such as a smartphone or tablet, a laptop, and/or a computer, a server 204 associated with a database 206 for storing and retrieving the user account information and/or merchant information, a point-of-sale (POS) device 208, e.g. a card terminal, website, mobile app, used by the merchant to initiate a payment transaction. User device 202, the server 204 and the POS device 208 may be in communication with each other via a network 210. Network 210 may be any type of network known to one of ordinary skill in the art (e.g. IP network) for enabling communication between user device 202, the POS device 208 and the server 204.

Server 204 may include a rebate viewing application which is downloadable by the user for installation on the user device 202. The user may download an application from the server 204 on their user device 202, e.g. a smart phone, tablet, or laptop computer, via the network 210. The application may include a user interface that may be updated in real-time to display rebate information of a payment mode for a transaction. When making a purchase, the user may open the application on the user device 202. Before using the system, the user may be prompted to input their various forms of payment such as credit cards, bank cards, debit cards, bank accounts, e-wallets, prepaid accounts, etc. into the system 200 via the application. The user may subscribe to the system 200 via the application and have a user account and be issued a user account identifier or ID registered with system. When the mentioned information is received by the server 204, a user account entry or record may be created in a user account database and the information is stored in the user account entry. Upon subscribing to the system, the user may specify the payment modes (e.g., credit cards, bank cards, debit, etc.) that the user wishes to carry out the transaction on. Thus, after subscribing and registering with the system 200, the user may access the application on the user device 202 and receive, in real-time, rebate information for each of the plurality of payment modes associated with the user's account. System 200 may be configured to determine rebate information for each of the plurality of payment modes. A merchant may register with the server 204 and the merchant may be issued a merchant identifier associated to a merchant account which may include the merchant's information, e.g. the merchant type, merchant website, etc.

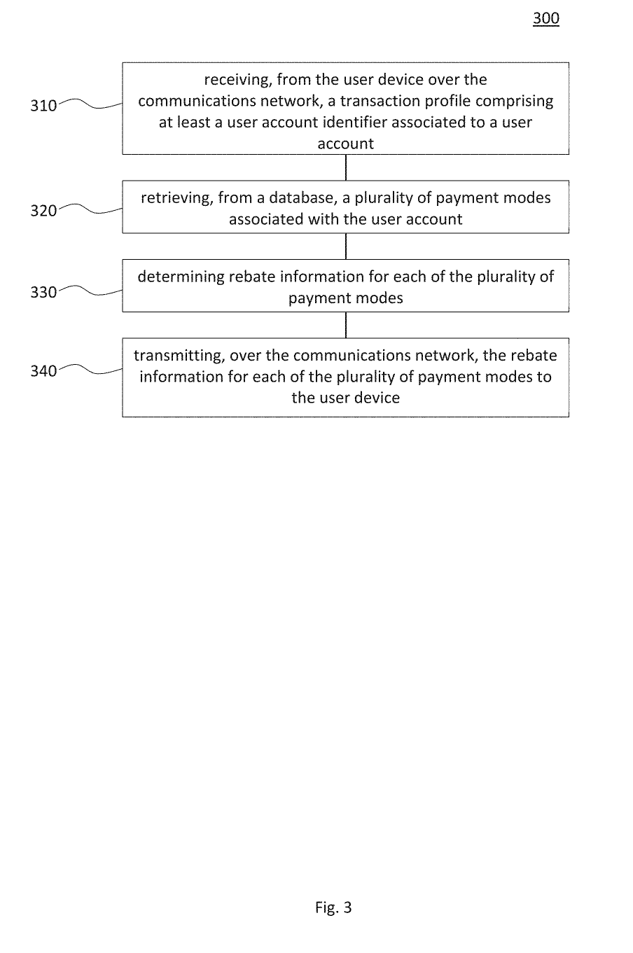

FIG. 3 shows an example of a method 300 of providing rebate information over a communication network to a remote user device 202 of a user based on the system 200. Method 300 includes, in step 310, receiving, from the user device 202 over the communication network 210, a transaction profile which includes at least a user account identifier associated to the user account. Further, the method 300 includes, in step 320, retrieving, from a database 206, e.g. the user account database, a plurality of payment modes associated with the user account based on the user account identifier. In step 330, the method 300 determines rebate information for each of the plurality of payment modes and, in step 340, transmits, over the communication network 210, the rebate information for each of the plurality of payment modes to the user device 202.

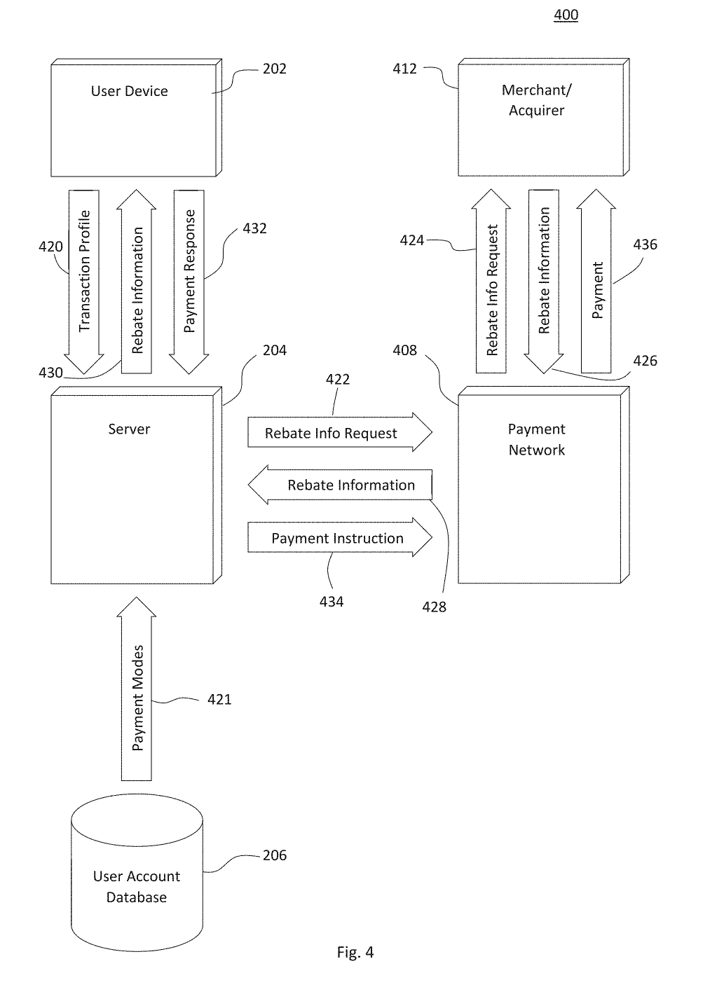

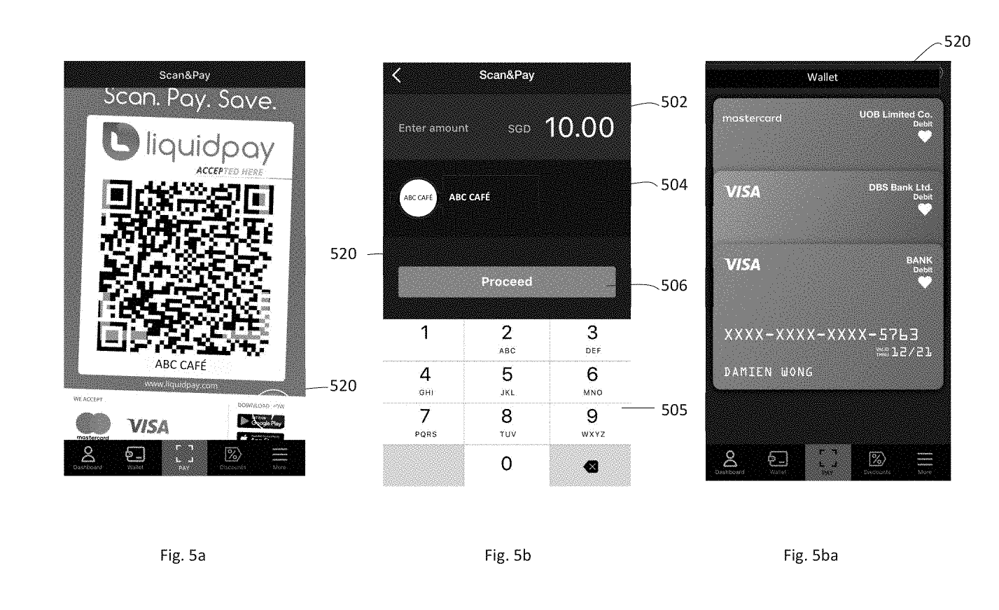

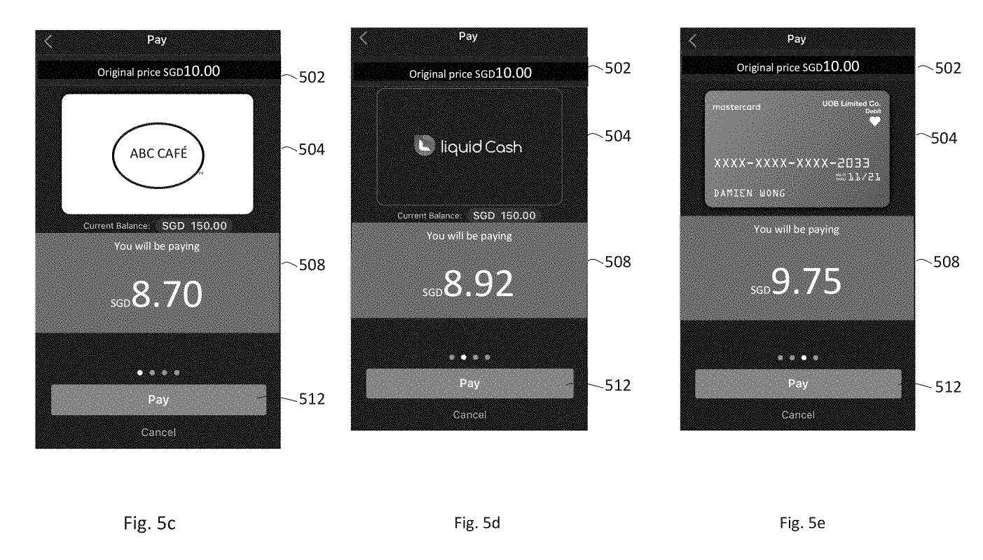

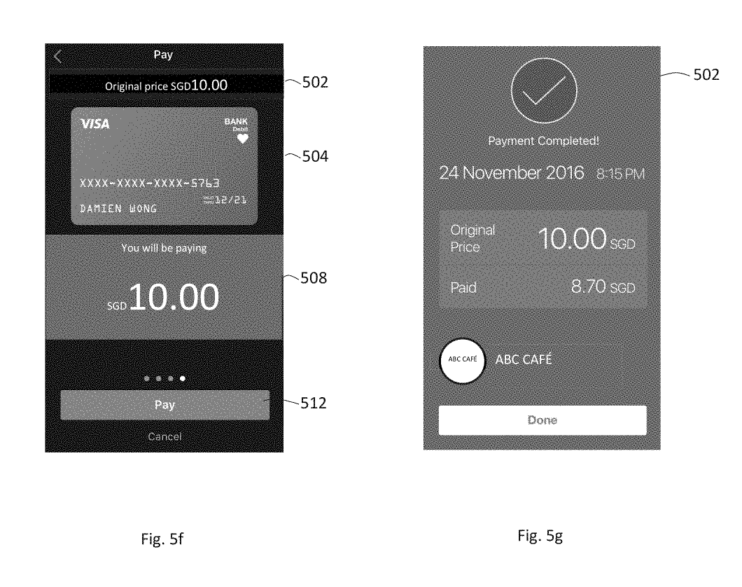

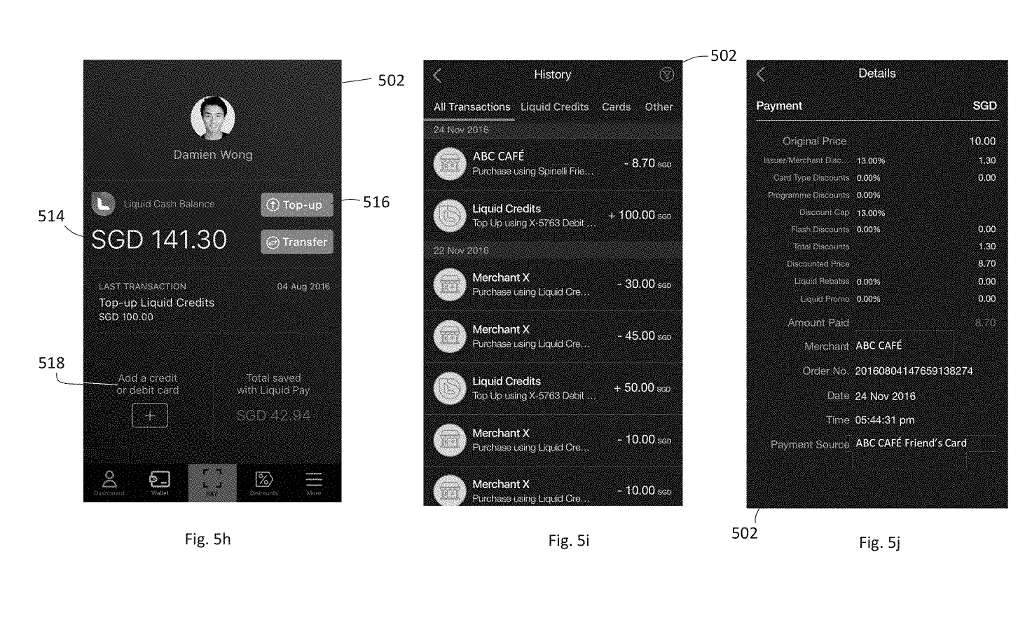

FIG. 4 shows an example of a schematic flow diagram of the method 300. Referring to FIG. 4, the user may use the system 200 to make a payment for a transaction, e.g. to buy an item. The user may use the user device 202 to record a transaction profile of the transaction (refer to FIG. 5a). User device 202 may transmit the transaction profile to the server 204 at 420. Server 204, upon receiving the transaction profile, may retrieve relevant data, e.g. the user account identifier associated to the user account and/or the merchant identifier associated to the merchant, etc., that is associated with the transaction. Based on the user account identifier, the server 204 retrieves the plurality of payment modes associated with the user account from a user account entry which is associated with the user account identifier from a user account database 206 at 421. Server 204 may generate the rebate information based on each of the plurality of payment modes. Server 204 may transmit a rebate information request to a payment network 408 to request for rebate information for each of the plurality of payment modes at 422. Upon receiving the rebate information request, the payment network 408 may transmit a rebate information request to the respective entities 412, e.g. merchant, acquirer and/or issuer, to request for rebate information at 424. Entities 412 may respond to the rebate information request by transmitting the rebate information to the payment network 408 at 426. Payment network 426 may thereafter transmit the rebate information to the server 204 at 428. Server 204 may retrieve the rebate information for each of the plurality of payment modes from at least one of the entities 412, e.g. merchant, acquirer and issuer. Upon receiving the rebate information, the server 204 transmits the rebate information for each of the plurality of payment modes to the user device 202 at 430. User device 202 may therefore receive the rebate information for each of the plurality of payment modes.

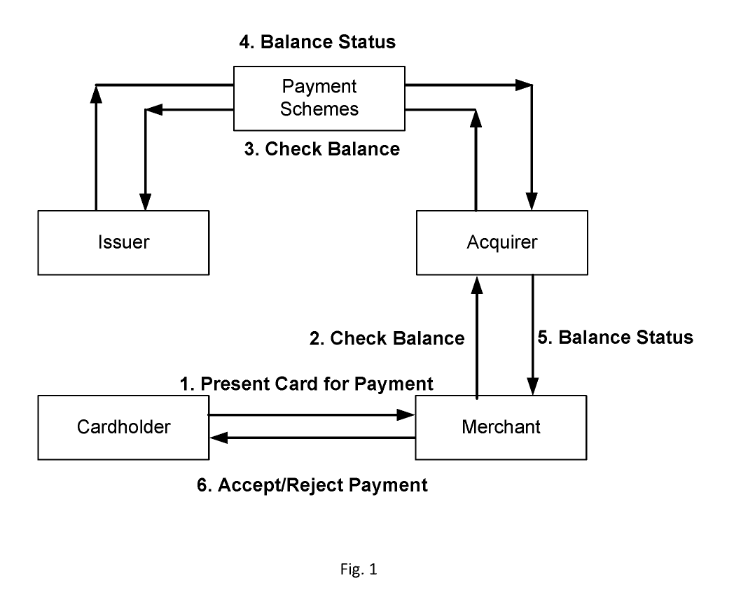

Server 204 may use an algorithm to calculate and present in real time to the user the rebate information for each of the plurality of payment modes. Server 204 may transmit the plurality of payment modes to the user device 202. User device 202 may receive the plurality of payment modes from the server 204. Upon receiving the rebate information, the user device 202 may display the rebate information for each of the plurality of payment modes on the a display or display screen of the user device 202 for the user to view the rebate information. User may select a payment mode and effect the payment of the transaction based on the rebate information. A rebate may be given to the user for the transaction based on the payment mode selected. User device 202 may transmit a payment response to the server 204 upon receiving the selection of the payment mode. Server 204 may receive the payment response from the user device 202 at 432. Payment response may include a payment mode selected from the plurality of payment modes by the user. Once the payment response is received, the server 204 may initiate a payment transaction to the merchant by transmitting a payment instruction to the payment network 408 at 434. Payment instruction may include at least the user account identifier and the merchant identifier. Payment instruction may include the transaction amount for the selected payment mode, wherein the transaction amount is incorporated the rebate information. When the payment network 408 receives the payment instruction, the payment network 408 may authenticate and carry out the process as shown in FIG. 1, e.g. to check the balance status of the user, and pay the entities 412, e.g. merchant or acquirer, at 436. Upon receiving the payment, the transaction is complete. Server 204 may transmit a notification to the user device 202 to notify the user that the transaction has been completed.

As one of ordinary skill in the art may appreciate that the system 200 is able to provide rebate information to the consumer and thereafter provide the consumer with the rebate real time. As the rebate information to the consumer is obtained from the merchant/issuer via the server 204 and the payment instruction is initiated by the server 204 directly to the payment network 408, the rebate may be made directly between the merchant/issuer and the user without any intervention from the merchant/issuer. For example, the issuer need not make any merchant arrangement or require the merchant to install any software on the merchant's devices or terminals. Therefore, the rebate process is straightforward and does not require additional resources to implement.

Rebate information may be based in part or completely on (a) the actual transaction cost to the merchant, which may be based on interchange, merchant discount rates, card scheme-related fees, bank rates and foreign exchange rates, and/or (b) the transaction cost to the user, which may be in the form of foreign exchange rates. Rebate information may be a rebate amount, loyalty points, air miles, etc. Rebate information may be generated based on the sale amount such that server 204 may calculate the rebate amount based on the sale amount of the purchase. System 200 may determine the rebate information for each of the plurality of payment modes associated with the user account in accordance with the merchant identifier or the merchant type. These transaction cost may further be based on the choice of method of payment or type of card used by the user. If the transaction cost is lowered, the merchant may pass the difference in transaction cost as a rebate to the user. Transaction cost and rebate may depend on the sale amount or may be independent from the sales amount. Rebate may be fixed or predetermined based on the payment mode.

Transaction profile may include at least and at least one of (i) the payment mode (e.g. payment card, bank account, etc.), (ii) the card type, (iii) the sale amount, (iv) the merchant type, (v) the location of merchant and user, (vi) the applicable foreign exchange rates on the day of the transaction, (vii) the user account identifier, and (viii) the merchant identifier. All of data of the transaction profile may be retrieved only from the user device 202. However, it is possible that the data of the transaction profile to be retrieved partly from the user device 202 and partly from the merchant's profile registered with the server 204. The data of the transaction profile may also be retrieved from the merchant identifier (e.g., a QR Code), the merchant's device (such as the merchant's POS device, card terminal or mobile) and/or the merchant's website.

Plurality of payment modes may include at least one of: payment by payment card (e.g. credit card), payment by merchant card, reward card, direct debit from bank account.

FIG. 5a-5f show examples of the screen captures of the display 520 of the user device 202. Referring to FIG. 5a, the user captures a merchant code with the user's user device 202. The merchant code may be an image, e.g. a QR code, which may be captured by a user device with image capturing capability, e.g. camera, or a text, e.g. alphanumeric text, which may be keyed in to the user device 202. The merchant code may include at least an original transaction amount of the purchase, e.g. SGD10.00, the merchant identifier. As shown in FIG. 5b, the user device may display the original transaction amount 502 and the merchant information 504 based on transaction information. Application may provide an input portion 505, e.g. number pad, configured to allow the user to enter the original transaction amount. In FIG. 5b, the user device 202 may display a user input button 506, e.g. “Proceed” button, configured to receive the user input to proceed with the transaction. When the user is agreeable with the information displayed, the user may tap on the user input button 506 to initiate the payment transaction. User device 202 may receive a user proceed instruction to proceed with the payment transaction. User device 202 may generate the transaction profile to be transmitted to the server 204. As explained above, the server 204, upon receiving the transaction profile, may retrieve rebate information for each of the plurality of payment modes and display the rebate information on the user device 202.

Rebate information may be presented on the user device 202 to the user. Rebate information may be incorporated into the original transaction amount before being transmitted to the user device 202. Server 204 may compute a transaction amount for each of the plurality of payment modes based on the original transaction amount and the relevant rebate information for each of the plurality of payment modes. Transaction amount may be obtained by deducting the rebate amount from the original transaction amount. Server 204 may thereafter transmit the transaction amount for each of the plurality of payment modes to the user device 202. Further, the transaction amount for each of the plurality of payment modes may be presented to the user in real time. FIG. 5ba shows a plurality of payment modes presented on the display 520 for the user's selection.

FIG. 5c-FIG. 5f shows a plurality of payment modes being displayed on the display 520 of the user device 202. Referring to FIG. 5c, the user device 202 may receive the transaction amount for each of the plurality of payment modes and display the transaction amount 508 on the display 520 of the user device. In this example, the transaction amount 508 incorporates the rebate information. User device 202 may display the original transaction amount 502 on the same display 520. In addition, the merchant information 504 may be displayed on the display 520. User device 202 may display a payment instruction button 512 configured to receive a payment instruction input from the user. User may approve the payment mode by tapping on the payment instruction button 512. FIG. 5c shows the transaction amount 508 for the payment transaction made using the merchant card or if the transaction is directly debited from the user account with the merchant. FIG. 5d shows the transaction amount 508 for the payment transaction made using the system payment card. In this example, the system 200 may be known as “Liquid” and the system payment card may be known as “LiquidCash”. FIG. 5e shows the transaction amount 508 for the payment made using a payment card, e.g. credit card, from a first issuer, e.g. a bank. FIG. 5f shows the transaction amount 508 for the payment made using a payment card from a second issuer. As shown in FIG. 5c-5f, the user device 202 may display the original transaction amount 502 and a transaction amount 508 which is based on the original transaction amount 502 and the rebate amount for each payment mode. User device 202 may also display the merchant or issuer information 504 on the same display 520. Using FIG. 5c as an example, the rebate information has been incorporated into the transaction amount. In FIG. 5c, the original transaction amount 502, e.g. SGD10.00, and the transaction amount 508, e.g. SGD8.70, are being displayed on the display 520. User may view the plurality of payment modes on the display 520 and decide the payment mode that he or she wishes to pay with. User may select the payment mode with the lowest transaction amount, i.e. via the merchant card as shown in FIG. 5c. Once the user has decided on the payment mode, the user may tap on the pay instruction button 512 to select the payment mode desired. As explained above, the payment transaction may be made via the payment network 408. When the server 204 receives the payment confirmation from the payment network 408, the server 204 may transmit a payment confirmation to the user device 202 to inform the user that the payment transaction has been completed. FIG. 5g shows an example of the display 520 of the user device displaying the payment completion. In some scenarios, the user may not necessarily choose the payment mode which provides a rebate as the user may have other reasons for adopting a particular payment mode or choice of card for other reason, e.g. to acquire air miles or points of the card issuer.

FIG. 5h shows a landing page of the application. As shown in FIG. 5h, the application displays a balance amount 514 the user has with the merchant or issuer. Application further displays a top up input button 516 configured to allow the user to top up the balance amount of the user account with the merchant or issuer. Application further displays a card input button 518 configured to allow the user to add a payment card option to the user account entry of the user account. FIG. 5i shows a history page of the application where the application displays the payment history of the user. FIG. 5j shows a breakdown of the payment transaction. As shown in FIG. 5j, the application displays the original price of the purchase, the issuer/merchant discount, card type discount, discount cap, total discount, rebate information such as merchant rebate, merchant promotional discount, transaction amount, etc.

In the above example, the system 200 may rebate the user in real time, i.e. at the time of purchase, the transaction amount may automatically be reduced, giving an instant reduction in the purchase price or sale amount to the user. In some embodiments, the system 200 may present the rebate options associated with each payment mode to the user in real time, e.g. on the display 520, prior to the user making payment. In this way, the user may be able to choose the optimal payment mode and therefore, the applicable rebate option desired in real time. In another example, a rebate is provided in real time, but the rebate is transferred into a credit account (e.g., e-wallet or stored value facility) for future spending. In another example, the rebate amount may be presented in real time but not credited in real time. Thus, rebates can be either credited/reversed into the user's account or into a credit account (e.g., e-wallet or stored value facility). In the case where the rebate is in terms of benefits, e.g. loyalty points, air miles, the rebate may be credited to the user account record in the user account database or a user record in the merchant database.

System 200 may present to the user one or more options for a range of rebates or price reductions based on a plurality of variables applicable to the transaction. System 200 may present the range of rebates in real time. The rebates or the range of rebates may be determined based on at least one of the following variables: the payment method chosen by the user (payment card, direct debit or payment from a bank account), the type of payment card used (such as signature, platinum or gold), the location where the payment is made, and the type of merchant the payment is made to.

System 200 may generate a rebate alert for the rebate, such that the rebate alert contains the rebate information for each of the plurality of payment modes associated with the user account. System 200 may transmit the rebate alert to the user device 202. Upon receiving the rebate alert, the rebate viewer application on the user device 202 may update on the user display 520 in real-time to display, on the user device 202, the rebate alert for each of the plurality of payment modes. Further embodiments include a predictive model for providing rebates to users based on an expected future purchase.

While the transaction amount with the rebate information incorporated may be transmitted to the user device 202, it is possible to transmit the rebate information to the user device 202 before being incorporated into the original transaction amount. User device 202 may be configured to calculate the transaction amount for each of the plurality of payment modes after receiving the rebate information from the server 204.

The transaction amount may include the applicable fees for each of the plurality of payment modes and/or with the calculation of relevant rebates applicable to the transaction for each of the plurality of payment modes. Server 204 may be configured to calculate the transaction cost for each of the plurality of payment modes by retrieving data for the transaction cost and calculate the transaction cost for each of the plurality of payment modes that is provided in the user account and/or available for the specific merchant type. Once the server 204 receives the transaction cost for each of the plurality of payment modes, server 204 may compute the transaction cost and the sale amount of the purchase to generate the transaction amount for each of the plurality of payment modes. Server 204 may then transmit the transaction amount for each of the plurality of payment modes to the user device 202 for the user's reference and selection.

System 200 may be configured to determine payment processing fees or transaction cost of each of the plurality of payment modes based on a plurality of payment variable. The transaction cost for each of the plurality of payment modes may be determined by the system 200 based on at least one of the following: card interchange fees; merchant discount rates; card scheme-related fees, foreign exchange and other bank rates. For example, the payment method or mode, e.g. payment card, direct debit, payment from bank account; the type of payment card; the location where the payment is made; and the merchant type the payment is made to. System 200 may present the transaction amount for each of the plurality of payment modes based on the transaction cost and/or the rebate information in real time to users. In certain scenarios, the merchant may obtain discount from the transaction cost and may pass the discount as rebate to the user.

The user may use the user device 202, e.g. a mobile device, for mobile payments. By using the system 200 to make the payment, users are able to have the option of rebates, thereby saving on the cost of their purchase. Accordingly, the user is able to determine within a very short timeframe, almost instantly, which payment mode is desired and consequently, the rebate the user would like to receive. Merchants may also choose to retain some of the savings and not pass the entire savings to the user as a rebate. System 200 may be operated across all forms of payment modes known to one of ordinary skill in the art and does not limit the user's choice of payment.

Furthermore, in some embodiments, a POS device, card terminal, website, mobile app, or merchant identifier (e.g., a QR code) 308 associated with the merchant may be integrated into the system 200 via an application programming interface or other integration methods.

System 200 may be a platform for making payments that interact with the traditional payment systems in use. As an example, users may install the system in the form of an application on their computing device such as a smart phone, tablet, or laptop computer. Application may include a user interface that is updated in real-time to display rebate information for a transaction.

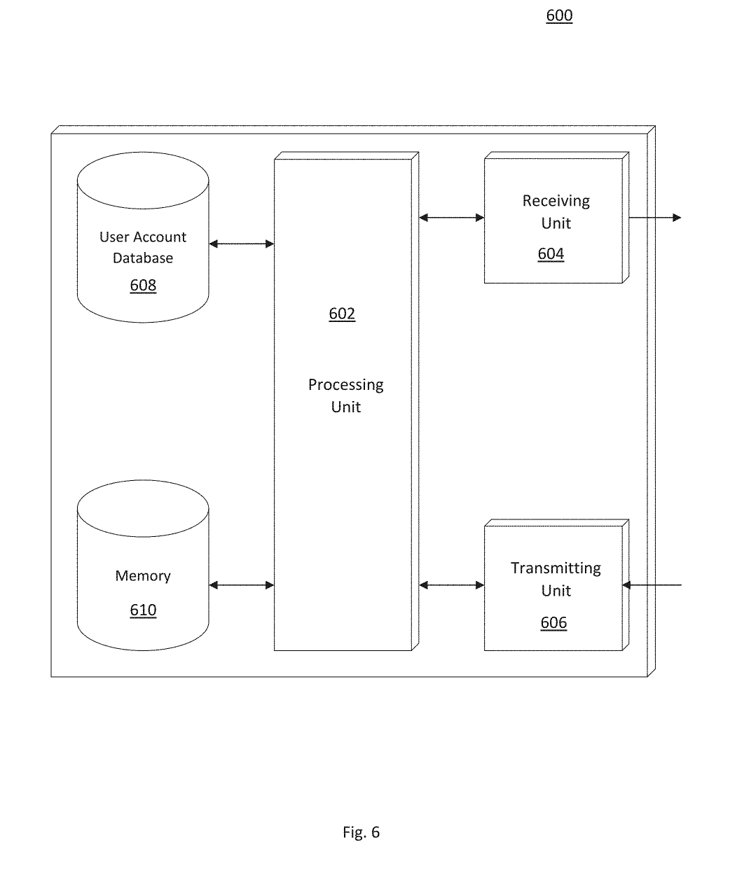

FIG. 6 shows an example of the server 204 of the system 200. Server 204 may include a processing unit 602, a receiving unit 604 and a transmitting unit 606 in communication with the processing unit 602. Processing unit 602 may assess at least one database 608, e.g. user account database and in communication with memory 610. User account database 608 is configured to store at least one user account entry associated to a user account, each user account entry comprises at least a plurality of payment modes. It will be apparent to a person having skill in the relevant art that the server 204 as shown in FIG. 6 is provided as illustration only and may not be exhaustive to all possible configurations of the server 204 suitable for performing the functions as discussed herein.

Receiving unit 602 may be configured to receive data over one or more networks via one or more network protocols. Receiving unit 602 may be configured to receive, from the user device over the communication network, a transaction profile having at least a user account identifier associated to a user account. Receiving unit 602 may be configured to receive a payment response from the user device 202 (not shown in FIG. 6), such that the payment response may include a payment mode selected from the plurality of payment modes by the user. Receiving unit may be configured to receive rebate information from the payment network. Receiving unit may be configured to receive a payment response from the user device 202, such that the payment response may include a payment mode selected from the plurality of payment modes by the user.

Processing unit 602 may be configured to retrieve the user account identifier from the transaction profile and retrieve, from the user account database, a plurality of payment modes associated with the user account based on the user account identifier and determine rebate information for each of the plurality of payment modes. Each user may have an account data entry stored in the database 608 and may include data related to the user, e.g. user account identifier, account balance. The account identifier may be a unique value used for identification, such as an identification number, a payment account number, username, e-mail address, phone number, etc. The account balance may be a credit balance of the user. Processing unit 602 may be configured to retrieve at least one of merchant rebate information from a merchant database of the merchant and acquirer rebate information from an acquirer database of an acquirer. Processing unit 602 is configured to compute a transaction amount for each of the plurality of payment modes, such that the transaction amount is based on the rebate information, the transaction cost for each of the plurality of payment modes and the sale amount.

Transmitting unit 606 may be configured to transmit data over one or more networks via one or more network protocols. Transmitting unit 606 is configured to transmit, over the communication network, the rebate information for each of the plurality of payment modes to the user device 202. Transmitting unit may be configured to transmit payment instruction to the payment network to initiate payment to the merchant. Transmitting unit may be configured to transmit the plurality of payment modes to the user device 202. Transmitting unit may be configured to transmit the transaction amount for each of the plurality of payment modes to the user device, wherein the transaction amount incorporates the rebate information.

System 200 may include a system database such that the system database may be configured to store a rebate viewing application which is downloadable by the user for installation on the user device 202. System database may be configured to store a user account record which includes a user identifier, a user balance for a user. The data in the user account record may be stored in the user account entry in the database 206.

As understood by one of ordinary skill in the art, the present invention can be implemented with special purpose computers, devices, and servers that are programmed to implement the embodiments described herein.

The present invention has been fully described with reference to the drawing figures. Although the invention has been described based upon these preferred embodiments, to those of skill in the art, certain modifications, variations, and alternative constructions would be apparent, while remaining within the spirit and scope of the invention.

What is claimed is:

1. A method of providing rebate information over a communication network to a remote user device of a user, the method comprising:
receiving, from the user device over the communication network, a transaction profile comprising at least a user account identifier associated to a user account;
retrieving, from a database, a plurality of payment modes associated with the user account based on the user account identifier;
determining rebate information for each of the plurality of payment modes; and
transmitting, over the communication network, the rebate information for each of the plurality of payment modes to the user device.

2. The method of claim 1, further comprising receiving a payment response from the user device, wherein the payment response comprises a payment mode selected from the plurality of payment modes by the user.

3. The method of claim 1, wherein the transaction profile further comprises a merchant identifier associated to a merchant, wherein the method further comprises transmitting payment instruction to a payment network to initiate payment to the merchant.

4. The method of claim 3, further comprising retrieving at least one of merchant rebate information from a merchant database of the merchant or acquirer rebate information from an acquirer database of an acquirer.

5. The method of claim 1, further comprising providing a rebate viewing application which is downloadable by the user for installation on the user device.

6. The method of claim 1, further comprising transmitting the plurality of payment modes to the user device.

7. The method of claim 1, wherein the transaction profile includes a sale amount for a good or service that the user intends to purchase, wherein the method further comprises computing a transaction amount for each of the plurality of payment modes, wherein the transaction amount is based on the rebate information, a transaction cost for each of the plurality of payment modes and the sale amount.

8. The method of claim 7, wherein the rebate information is generated based on the sale amount.

9. The method of claim 1, wherein transmitting the rebate information for each of the plurality of payment modes to the user device comprises transmitting a transaction amount for each of the plurality of payment modes to the user device, wherein the transaction amount incorporates the rebate information.

10. The method of claim 1, wherein the rebate information is generated based on at least one of a merchant transaction cost or a user transaction cost.

11. A system for providing rebate information over a communication network to a remote user device of a user, the system comprising:
a user account database configured to store at least one user account entry associated with a user account, each user account entry comprising at least a plurality of payment modes,
a receiving unit configured to receive, from the user device over the communication network, a transaction profile comprising at least a user account identifier associated with the user account;
a processing unit configured to:
retrieve, from the user account database, a plurality of payment modes associated with the user account based on the user account identifier; and
determine rebate information for each of the plurality of payment modes; and
a transmitting unit configured to transmit, over the communication network, the rebate information for each of the plurality of payment modes to the user device.

12. The system of claim 11, wherein the receiving unit is configured to receive a payment response from the user device, wherein the payment response comprises a payment mode selected from the plurality of payment modes by the user.

13. The system of claim 11, wherein the transaction profile further comprises a merchant identifier associated to a merchant, wherein the transmitting unit is configured to transmit payment instruction to a payment network to initiate payment to the merchant.

14. The system of claim 13, wherein the processing unit is configured to retrieve at least one of merchant rebate information from a merchant database of the merchant or acquirer rebate information from an acquirer database of an acquirer.

15. The system of claim 11, further comprising a system database configured to store a rebate viewing application that is downloadable by the user for installation on the user device.

16. The system of claim 11, wherein the transmitting unit is configured to transmit the plurality of payment modes to the user device.

17. The system of claim 11, wherein the transaction profile includes a sale amount for a good or service that the user intends to purchase, wherein the processing unit is configured to compute a transaction amount for each of the plurality of payment modes, wherein the transaction amount is based on the rebate information, a transaction cost for each of the plurality of payment modes and the sale amount.

18. The system of claim 17, wherein the rebate information is generated based on the sale amount.

19. The system of claim 11, wherein the transmitting unit is configured to transmit a transaction amount for each of the plurality of payment modes to the user device, wherein the transaction amount incorporates the rebate information.

20. The system of claim 11, wherein the rebate information is generated based on at least one of a merchant transaction cost or a user transaction cost.
